(19) United States
(12) Patent Application Publication
(10) Pub. No.: US 2010/0161914 A1
(43) Pub. Date: Jun. 24, 2010

(54) AUTONOMOUS MEMORY SUBSYSTEMS IN COMPUTING PLATFORMS

(76) Inventors: Sean S. Eilert, Penryn, CA (US); Mark Leinwander, Folsom, CA (US); Sridharan Sakthivelu, Dupont, WA (US); John L. Baudrexl, Olympia, WA (US)

Correspondence Address: INTEL CORPORATION;c/o CPA Global, P.O. BOX 52050, MINNEAPOLIS, MN, 55402, US

(21) Appl. No.: 12/343,137

(22) Filed: Dec. 23, 2008

(51) Int. Cl. G06F 12/00

(52) U.S. Cl. 711/154; 711/E12.001; 710/22; 711/167

(57) ABSTRACT

Embodiments of the invention are generally directed to systems, methods, and apparatuses for autonomous memory subsystems in computing platforms. In some embodiments, the autonomous memory mechanism includes one or more autonomous memory logic instances (AMLs) and a transaction protocol to control the AMLs. The autonomous memory mechanism can be employed to accelerate bulk memory operations. Other embodiments are described and claimed.

### TECHNICAL FIELD

Embodiments of the invention generally relate to the field of computing systems and, more particularly, to systems, methods and apparatuses for autonomous memory subsystems in computing platforms.

### BACKGROUND

The processing power of computing platforms is increasing with the increase in the number of cores and the number of threads on computing platforms. This increase in processing power leads to a corresponding increase in the demands placed on system memory. For example, read and write operations to system memory increase as the core and thread count increase. There is a risk that memory accesses will become a substantial performance bottleneck for computing platforms. This is particularly true for bulk memory operations.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high-level block diagram illustrating selected aspects of a computing system implemented according to an embodiment of the invention.

FIG. 2 is a block diagram illustrating selected aspects of autonomous memory logic (AML), according to an embodiment of the invention.

FIG. 3 illustrates selected aspects of an implementation in which AMLs are embedded within memory devices.

FIG. 4 illustrates selected aspects of an implementation in which one or more AMLs are embedded within a memory controller.

FIG. 5 illustrates selected aspects of an implementation in which AMLs are embedded within advanced memory buffers in a fully-buffered DIMM (FBD) system.

FIG. 6 illustrates selected aspects of an implementation in which AMLs are embedded within buffer-on-board (BOB) logic.

FIG. 7 is a block diagram illustrating selected aspects of the autonomous memory protocol, according to an embodiment of the invention.

FIG. 8 illustrates selected aspects of the software stack for autonomic memory, according to an embodiment of the invention.

FIG. 9 is a sequence diagram illustrating selected aspects of a generic autonomic operation, according to an embodiment of the invention.

### DETAILED DESCRIPTION

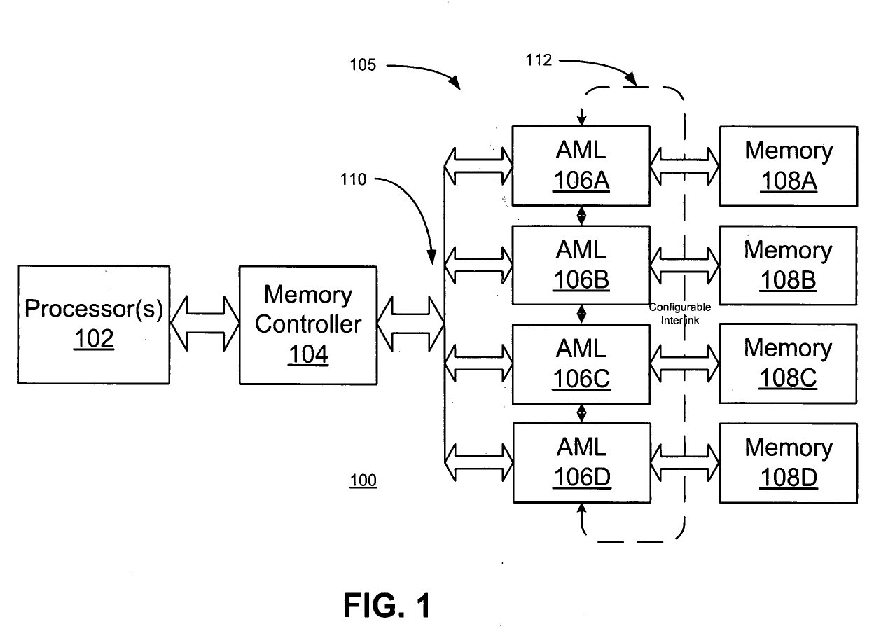

Embodiments of the invention are generally directed to systems, methods, and apparatuses for autonomous memory subsystems in computing platforms. In some embodiments, the autonomous memory mechanism includes one or more autonomous memory logic instances (AMLs) and a transaction protocol to control the AMLs. The term AML refers to logic located close to (or embedded within) a memory device that can execute primitive operations on data stored in the memory device. The transaction protocol refers to software, firmware, and/or hardware that provides the macro-operations for one or more AMLs. That is, the transaction protocol provides macro-operations that direct the micro-operations implemented by the AMLs. As is further discussed below, with reference to FIGS. 1-9, the autonomous memory mechanism can be employed to accelerate bulk memory operations.

FIG. 1 is a high-level block diagram illustrating selected aspects of a computing system implemented according to an embodiment of the invention. System 100 includes processor(s) 102, memory controller 104, AMLs 106, and memory devices 108. In alternative embodiments, system 100 may have more elements, fewer elements, and/or different elements.

Processor(s) 102 may be any of a wide range of general-purpose and special-propose processors including, for example, a central processing unit (CPU) having one or more cores and/or one or more processors. Memory controller 104 controls the transfer of data to and from memory subsystem 105. In some embodiments, memory controller 104 is integrated with processor(s) 102. In alternative embodiments, memory controller 104 is part of a chipset that supports processor(s) 102.

Software executing on processor(s) 102 may cause data to be transferred to and from memory subsystem 105. To implement this transfer, processor(s) 102 send instructions to memory controller 104. Memory controller 104 translates the instructions that it receives into a format that is appropriate for the implementation of memory subsystem 105.

In conventional systems, the memory controller has complete control of data movement within a memory subsystem and into/out of a memory subsystem. In contrast to conventional systems, memory subsystem 105 includes one or more AMLs 106. AMLs 106 enable memory subsystem 105 to perform primitive memory operations on itself.

AML's 106 provide a collection of primitive memory accelerator logic instances which are located close to the memory devices. These primitive memory accelerator logic instances can be employed to accelerate bulk memory operations. For example, memory controller 104 may be triggered by signals in the instruction flow to direct the accelerator logic to operate on various memory regions in parallel. The term “autonomous memory” is used to describe this mechanism because a processor no longer has to serially retrieve or manipulate the memory itself. Instead, the processor relies on its memory acceleration logic to manipulate memory, in bulk, on its behalf.

Embodiments of the invention, provide a greater overall performance benefit by offloading large (or memory intensive) operations from a processor into parallel accelerator transactions. This frees up memory bandwidth normally required to enable the processor instruction stream to operate on each memory word in sequence. Embodiments of the invention can also be used in conjunction with a hardware- or software-managed read/write RAM cache to hide large memory latencies, which may enable some non-volatile memory technologies to operate as a primary or extended memory.

One aspect of this invention is the placement of one or more embedded daisy chainable and/or cascadable Autonomous Memory Logic (AML) instances (e.g., 106A) into each memory element itself or into a nearby external controller such as the Advanced Memory Buffer (AMB) logic in the FBDIMM architecture, and also the implementation of an autonomic memory operation transaction protocol to control them. The AML instances may also be part of a CPU uncore complex and may be able to operate on behalf of a remote processor. The Autonomous Memory interface can be added to existing memory logic to provide additional functionality; in other words, a memory controller capable of issuing autonomic memory transactions may be backward-compatible, and can continue to issue standard load/store operations into its memory subsystem.

Memory devices 108 may be any of a wide variety of volatile and non-volatile memory devices. For example, memory devices 108 may include dynamic random access memory (DRAM) such as double data rate (DDR) or low power DDR (LP-DDR) In addition, memory devices 108 may be flash memory (NAND and/or NOR), phase-change memory, and the like. In some embodiments, memory devices 108 may include both volatile and non-volatile memory (e.g., DRAM and flash).

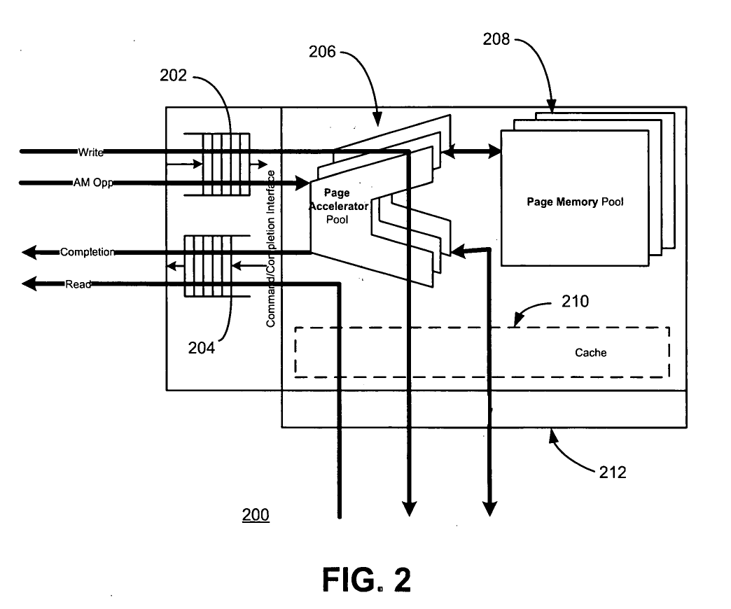

FIG. 2 is a block diagram illustrating selected aspects of autonomous memory logic (AML), according to an embodiment of the invention. AML 200 includes write queues 202, read queues 204, one or more page accelerators 206, one or more instances of page memory 208, memory interface 212, and (optionally) cache 210. In alternative embodiments, AML 200 may have more elements, fewer elements, and/or different elements.

The illustrated embodiment of AML 200 includes a pool of page accelerators 206. In some embodiments, each page accelerator (PA) is a tiny primitive controller (or hardware state machine) capable of operating within a given page boundary. The PA is directed to execute one or more primitive operations on some or all of its visible memory region by a control logic instance located logically above (“north of”) it. The PA contains no awareness of the instruction stream causing execution of a given primitive operation. The PA does not necessarily require any context or knowledge of system Virtual Addresses or Physical Addresses. That is, it can be designed to operate only on Relative Addresses within the given memory device(s) with which it is associated. In some embodiments, however, other degrees of address awareness may also be supported. The PA is not involved in any cache coherency operations/transactions; this activity continues to be managed by upstream memory control logic. Examples of specific primitive operations that the PA can perform include: a direct memory access (DMA) operation, a block copy operation, a block fill operation, a cyclic redundancy check (CRC) operation, an exclusive OR (XOR) operation, a search operation (e.g., a programmable/downloadable pattern match with wild card operation), a compare operation, a single instruction, multiple data (SIMD) operation, a secure delete operation, a trim operation, or a mask invert operation.

AML 200 also includes a pool of page memory 208. In some embodiments, a PA may use a page memory region as a temporary scratch pad. In some memory architectures this region can be directly mapped to the memory it is operating on. In such architectures, there may be no need for a separate page memory.

In general, the operations provided by AML 200 are relatively primitive. Most of the intelligence resides in the high-level software which distributes the load across the AMLs. This software could be part of the operating system (OS) or part of the application or even built into the compiler. For ease of discussion, the term autonomous memory library (AM library) is used to describe aspects of the software that control the AML(s).

In some embodiments, the AM library is a collection of software coded macros that provides one or more applications with access to the autonomic features of the memory subsystem. The AM library presents a variety of macro memory operations to the application and splits those operations (which we call autonomic threads or ATs) into multiple micro operations (which we call micro autonomic threads or μATs) that can then be performed by the AML logic instances. The macros can be invoked directly by Autonomous-Aware applications, or potentially be automatically inserted into the instruction stream by a compiler endowed with the intelligence to detect bulk memory operations and generate corresponding macro calls. In addition, these macros may convey information about the organization of the contents of the memory to the AMLs.

The illustrated embodiment of AML 200 includes optional read/write cache 210. Read/write cache 210 is an optional component in or near the memory controller and it can be used to cache data destined to or from the memory devices that may have relatively slow write characteristics, such as non-volatile memory. AML 200 does not enforce any cache coherency; this is handled by either hardware or software sitting outside the AML 200. Given the density of non-volatile memory technologies and their potential to create very large memory spaces, efficiently accelerating bulk memory operations may become a critical enabler of acceptable performance.

Autonomic memory acceleration transactions may be triggered in different ways depending on the implementation of the system. For example, in some embodiments, they may be triggered by regular write and read memory transactions to one or more special address regions that can be interpreted by the memory controller as offloaded instructions. Alternatively, the processor can issue new autonomic memory transaction types in response to new autonomic memory instructions, in which case the memory controller simply forwards the transaction. In other embodiments, a specific sequence of code or instructions that perform simple bulk memory operations can be detected by a compiler or interpreter, and converted into a matching functional set of one or more Memory Acceleration Transaction sequences. In yet other embodiments, different mechanisms may be used to trigger autonomic memory acceleration transactions.

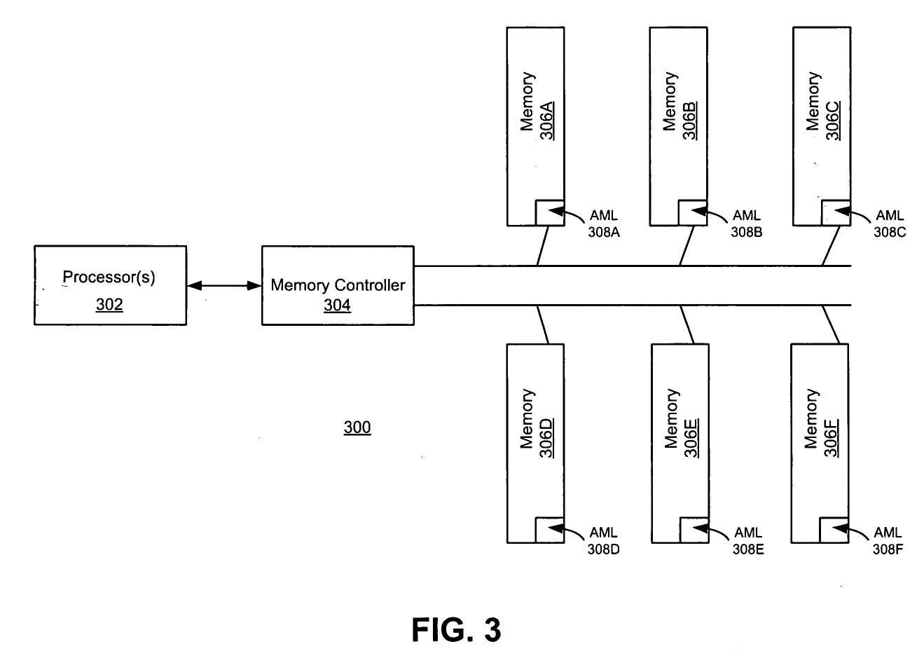

FIG. 3 illustrates selected aspects of an implementation in which AMLs are embedded within memory devices. System 300 includes processor(s) 302, memory controller 304, and memory devices 306. At least some of the memory devices 306 include an instance of AML 308. Memory devices 306 may be volatile and/or non-volatile memory. The AM library may reside north of memory controller 304. Each embedded AML 308 has access to one or more pages of the memory device within which the AML is embedded. It does not, however, have access to pages outside of the device within which it is embedded.

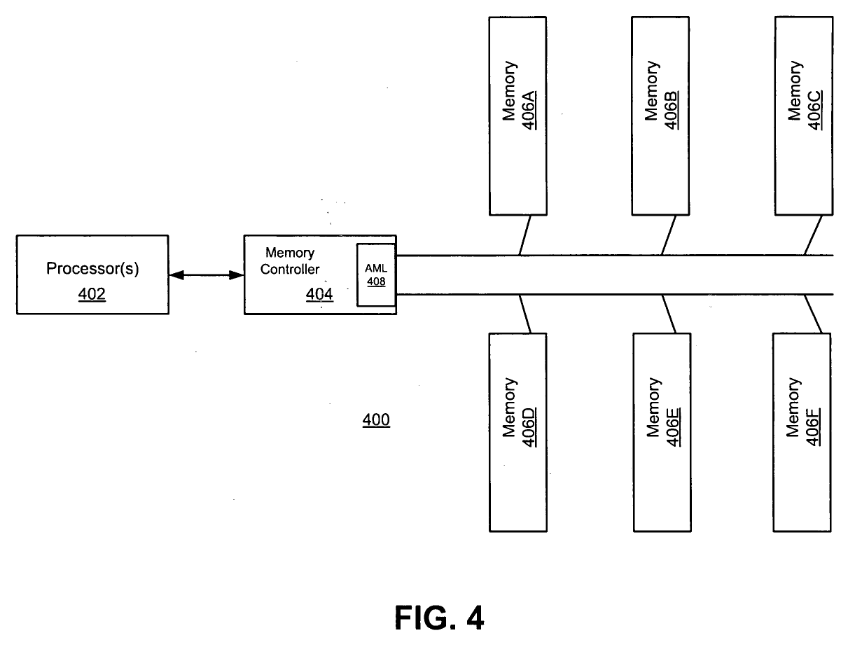

FIG. 4 illustrates selected aspects of an implementation in which an AML is embedded within a memory controller. System 400 includes processor(s) 402, memory controller 404, and memory devices 406. AML 408 is embedded within (e.g., integrated with) memory controller 404. Memory devices 406 may be volatile and/or non-volatile memory. The AM library may reside north of memory controller 404. AML 408 may control (e.g., provide primitive operations) for more than one of memory devices 406.

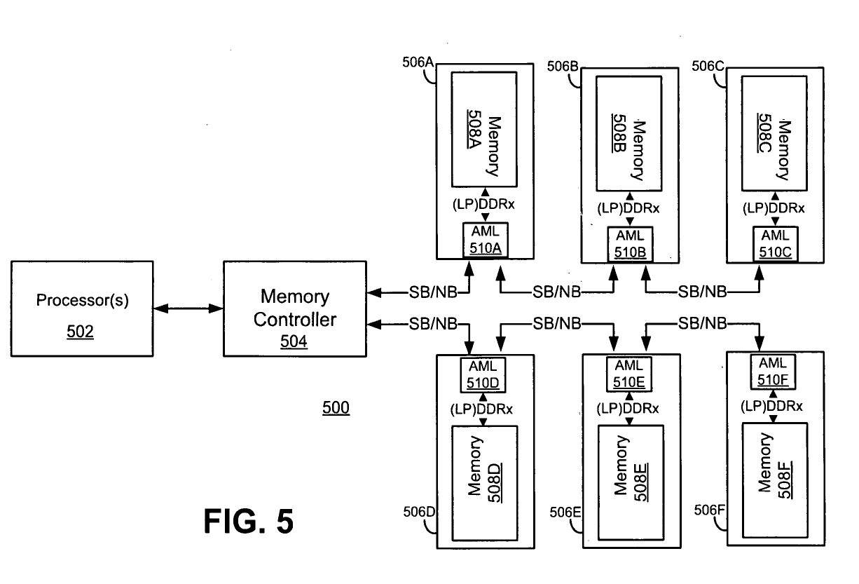

FIG. 5 illustrates selected aspects of an implementation in which AMLs are embedded within advanced memory buffers in a fully-buffered DIMM (FBD) system. System 500 includes processor(s) 502, memory controller 504, and memory modules 506. Each memory module 506 includes one or more memory devices 508. In addition, at least some of the memory modules 506 include an AML 510. Each AML 510 has access to at least one of the memory devices collocated with it on the same memory module. Memory devices 508 may be volatile and/or non-volatile memory.

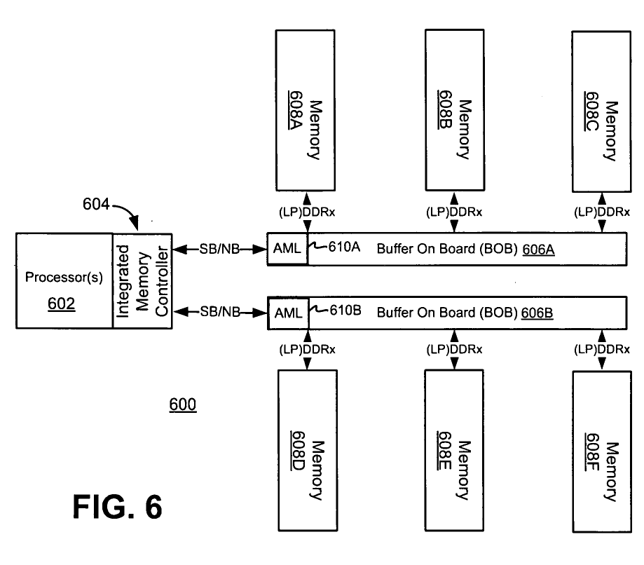

FIG. 6 illustrates selected aspects of an implementation in which AMLs are embedded within buffer-on-board (BOB) logic. System 500 includes processor(s) 602, integrated memory controller 604, buffer on board instances (BOB) 606, and memory devices 608. At least one BOB 606 includes AML 610. AML 610 has access to at least some of the memory devices that are attached to the BOB within which AML 610 is embedded. Memory devices 608 may be volatile and/or non-volatile memory.

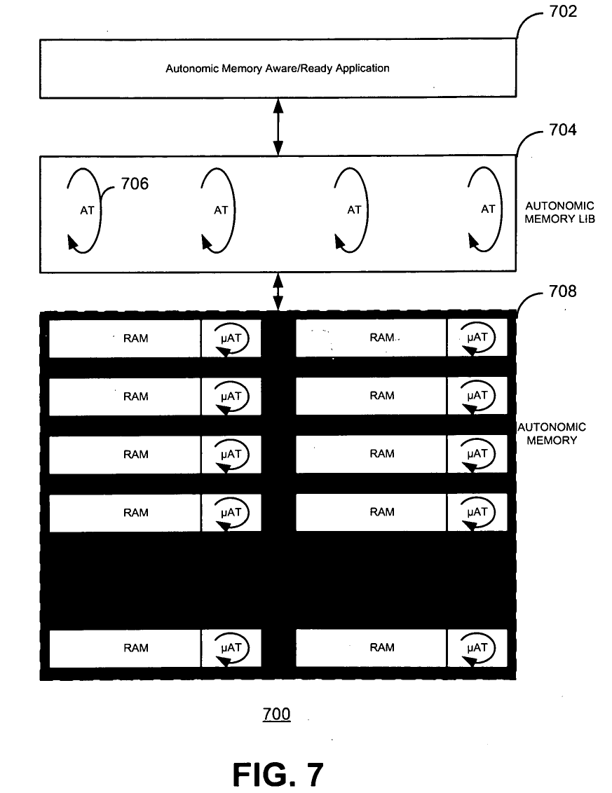

FIG. 7 is a block diagram illustrating selected aspects of the autonomous memory protocol, according to an embodiment of the invention. In the illustrated embodiment, autonomous memory system 700 is partitioned into various components including autonomic memory aware/ready application 702, AM library 704, and autonomic memory 708. In alternative embodiments, system 700 may be partitioned into more components, fewer components, and/or different components.

In some cases, application 700 is software that is already able to use AM library 704. In other cases, application 700 is compiled so that it is able to use AM library 704 (e.g., using an autonomic memory aware compiler). In either case, application 700 issues instructions that trigger AM library 704.

Autonomic library 704 includes autonomic threads (AT) 706. AT 706 provide macro operations which are split into micro autonomic threads (μATs) that can be performed by the AML instances. Consider, for example, the task of copying 4M bytes of information from one location in memory to another location. A compiler can distribute those operations into multiple autonomic threads. Each thread can operate on certain regions automatically without waiting for other threads to complete. Thus, a 4M byte operation might be divided into a number of 512K byte operations. Each 512K byte operation might have a corresponding thread that is responsible for copying information from a particular area of memory. The AM library 704 fragments those operations into device specific micro-threads which may be implemented by a corresponding PA. A 512K byte operation might be divided among multiple micro-threads and AM library 704 can dispatch those micro-threads to the appropriate PAs in the memory subsystem. As the PAs complete their operations, they provide notification to AM library 704 that their respective operations are complete.

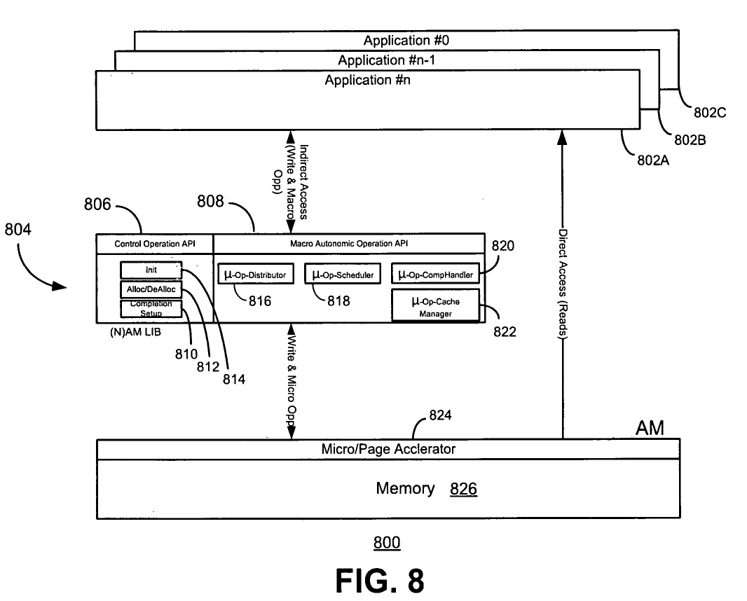

FIG. 8 illustrates selected aspects of the software stack for autonomic memory, according to an embodiment of the invention. System 800 includes applications 802, AM library 804, and autonomous memory 826. In other embodiments, system 800 may include more elements, fewer elements, and/or different elements.

System 800 illustrates an embodiment in which multiple applications 802, running in parallel, can utilize the autonomic memory features. For example, two or more of applications 802 may, in parallel, trigger AM library 804 to perform a autonomous memory transaction. The direct access line between memory 826 and applications 802 indicates that (at least in some embodiments) not all operations need to go through AM library 804. The direct access capability provides features such as backward compatibility and improved latency.

In the illustrated embodiment, AM library 804 is partitioned into control operations application programming interface (API) 806 and macro autonomic operation API 808. In other embodiments, AM library 804 may be partitioned into more components, fewer components, and/or different components. Control operations API 806 includes a set of operations (e.g., functions, procedures, methods, classes, protocols, etc.) to set up and control the resources of AM library 804. For example, in the illustrated embodiment, API 806 includes initiate operation 814, allocate/de-allocate operation 812, and completion setup operation 810.

Macro autonomic operation API 808 includes data-plane operations. For example, in the illustrated embodiment, API 808 includes μ-op-distributor operation 816, μ-op-scheduler operation 818, μ-op-CompHandler operation 820, and μ-op-cache manager operation 822. The μ-op-distributor operation 816 determines how to distribute an operation based on implementation logic. For example, it determines how to distribute a macro operation into a number of parallel micro operations. The μ-op-scheduler operation 818 schedules operations on PA instances. The μ-op-CompHandler operation 820 handles completion tasks after an operation is completed. For example, it might provide a notification when the PAs complete the micro operations. In other embodiments, API 808 may have more operations, fewer operations, and/or different operations.

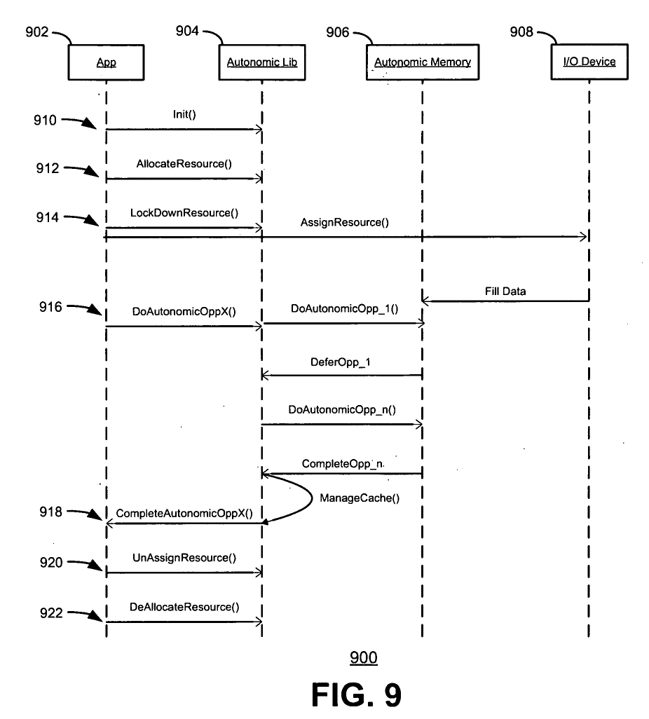

FIG. 9 is a sequence diagram illustrating selected aspects of a generic autonomic operation, according to an embodiment of the invention. Application 902 calls AM library 904 to initialize a specific software operation at 910. Application 902 then indicates that it wants to allocate resources at 912. The library allocates the resources and assigns them to, for example, an input/output device (908) or memory device (906) at 914.

AM library 904 splits the operation into a number of micro-operations and assigns the micro-operations to various PAs at 916. When all of the PAs complete their respective micro-operations, AM library 904 reports the completion of the operation to application 902 at 918. Application 902 then calls the AM library to un-assign and de-allocate the resources that were used for the operation (at 920 and 922).

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the description above, certain terminology is used to describe embodiments of the invention. For example, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. A system comprising:
software, to be executed on a processor, the software to trigger an autonomic memory transaction; and
a memory subsystem including at least one memory device and an autonomic memory logic instance (AML) coupled with the memory device, wherein the AML is to receive an instruction from the software and to execute an autonomic memory transaction independent of the processor.

2. The system of claim 1, wherein the software to trigger the autonomic memory transaction comprises software to access an address region associated with the autonomic transaction.

3. The system of claim 1, wherein the software to trigger the autonomic memory transaction comprises issuing an autonomic memory transaction.

4. The system of claim 1, wherein the software to trigger the autonomic memory transaction comprises converting an instruction associated with a bulk memory transaction into an instruction for an autonomic memory transaction.

5. The system of claim 4, wherein the AML comprises one or more page accelerators to execute a primitive operation on a page memory.

6. The system of claim 5, wherein the primitive operation comprises at least one of:
a direct memory access (DMA) operation,
a block copy operation,
a block fill operation,
a cyclic redundancy check (CRC) operation,
an exclusive OR (XOR) operation,
a programmable/downloadable pattern match with wild card operation,
a compare operation,
a single instruction, multiple data (SIMD) operation
a secure delete operation,
a trim operation, or
a mask invert operation.

7. The system of claim 5, wherein the AML further comprises one or more page memory instances, each page memory instance to provide temporary memory for a page accelerator.

8. The system of claim 7, wherein the AML further comprises a cache memory to cache data destined for the memory device.

9. The system of claim 1, wherein the memory device is a dynamic random access memory device.

10. The system of claim 1, wherein the memory device is a non-volatile memory device.

11. The system of claim 1, wherein data is stored in the memory subsystem and the software is to convey information about the organization of at least a portion of the data to the AML.

12. An apparatus comprising:
an autonomic memory logic instance (AML) to be coupled with a memory device, wherein the AML is to execute an autonomic memory transaction independent of a processor, responsive, at least in part, to receiving an indication to initiate the autonomic memory transaction from software executing on the processor.

13. The apparatus of claim 12, wherein the software is to provide the indication to initiate the autonomic memory transaction based, at least in part, on accessing an address region associated with the autonomic transaction.

14. The apparatus of claim 12, wherein the software is to provide the indication to initiate the autonomic memory transaction based, at least in part, on issuing an autonomic memory transaction.

15. The apparatus of claim 12, wherein the software is to provide the indication to initiate the autonomic memory transaction based, at least in part, on converting an instruction associated with a bulk memory transaction into an instruction for an autonomic memory transaction.

16. The apparatus of claim 12, wherein the AML comprises one or more page accelerators to execute a primitive operation on a page memory.

17. The apparatus of claim 16, wherein the primitive operation comprises at least one of:
a direct memory access (DMA) operation,
a block copy operation,
a block fill operation,
a cyclic redundancy check (CRC) operation,
an exclusive OR (XOR) operation,
a programmable/downloadable pattern match with wild card operation,
a compare operation,
a single instruction, multiple data (SIMD) operation
a secure delete operation,
a trim operation, or
a mask invert operation.

18. The apparatus of claim 16, wherein the AML further comprises one or more page memory instances, each page memory instance to provide temporary memory for a page accelerator.

19. The apparatus of claim 18, wherein the AML further comprises a cache memory to cache data destined for the memory device.

20. The apparatus of claim 12, wherein the memory device is a dynamic random access memory device.

21. The apparatus of claim 12, wherein the memory device is a non-volatile memory device.

22. The apparatus of claim 12, wherein the AML is capable of communicating with another AML.

23. The apparatus of claim 12, wherein the AML is part of a central processing unit uncore complex.

24. The apparatus of claim 23, wherein the AML is capable of operating on behalf of a remote processor.

25. A method comprising:
initiating an autonomic memory transaction with software executing on a processor; and
executing the autonomic memory transaction using, at least in part, an autonomic memory logic instance (AML) coupled with a memory device, wherein the AML is to execute the autonomic memory transaction independent of the processor.

26. The method of claim 25, wherein initiating the autonomic memory transaction comprises accessing an address region associated with the autonomic transaction.

27. The method of claim 25, wherein initiating the autonomic memory transaction comprises issuing an autonomic memory transaction.

28. The method of claim 25, wherein initiating the autonomic memory transaction comprises converting an instruction associated with a bulk memory transaction into an instruction for an autonomic memory transaction.

29. The method of claim 25, wherein the AML comprises one or more page accelerators to execute a primitive operation on a page memory.

30. The method of claim 29, wherein the primitive operation comprises at least one of:
a direct memory access (DMA) operation,
a block copy operation,
a block fill operation,
a cyclic redundancy check (CRC) operation,
an exclusive OR (XOR) operation,
a programmable/downloadable pattern match with wild card operation,
a compare operation,
a single instruction, multiple data (SIMD) operation
a secure delete operation,
a trim operation, or
a mask invert operation.

31. The method of claim 29, wherein the AML further comprises one or more page memory instances, each page memory instance to provide temporary memory for a page accelerator.

32. The method of claim 31, wherein the AML further comprises a cache memory to cache data destined for the memory device.

33. The method of claim 25, wherein the memory device is a dynamic random access memory device.

34. The method of claim 25, wherein the memory device is a non-volatile memory device.
